(19) United States
(12) Patent Application Publication
(10) Pub. No.: US 2024/0231883 A9
(43) Pub. Date: Jul. 11, 2024

(54) SYSTEMS AND METHODS FOR DEVELOPMENT AND DEPLOYMENT OF CLOUD SERVICES

(71) Applicant: OpsCanvas, Inc., Alexandria, VA (US)

(72) Inventors: Jason Turim, Chevy Chase, MD (US); Brian Kathman, Alexandria, VA (US)

(21) Appl. No.: 18/491,562

(22) Filed: Oct. 20, 2023

Related U.S. Application Data
(60) Provisional application No. 63/418,338, filed on Oct. 21, 2022.

(51) Int. Cl. G06F 9/455

(52) U.S. Cl. CPC G06F 9/45558; G06F 2009/4557; G06F 2009/45595

(57) ABSTRACT

Systems and methods for configuration of a cloud application are disclosed. Inputs including selections of graphical icons for addition to a graphical canvas area can be received from a client device. The graphical icons can be displayed by the graphical canvas area, wherein a topology of the cloud application is configured based on the graphical canvas area. An input including a selection of a graphical connection indicator between the graphical icons for addition to the graphical canvas area can be received. The graphical connection indicator can be displayed by the graphical canvas area and represent a network connection between a first and a second component corresponding to the first and second graphical icons. A cloud application can be caused to deploy to a cloud environment hosted by a cloud computing system, the cloud application having the topology indicated by the graphical canvas area.

### CROSS-REFERENCE TO RELATED APPLICATIONS

This application claims priority to and the benefit of U.S. Provisional Patent Application No. 63/418,338, filed Oct. 21, 2022, and entitled “SYSTEMS AND METHODS FOR DEPLOYMENT OF CLOUD SERVICES”, the entirety of which is incorporated herein by reference.

### TECHNICAL FIELD

The following disclosure is directed to methods and systems for configuration of cloud-based applications, more specifically, methods and systems for deployment of cloud-based applications using a graphical user interface.

### BACKGROUND

Cloud computing techniques have presented several opportunities for improvements for software companies, including improvements to operating costs, customer satisfaction, and/or incident response times. Based on the development of cloud computing techniques, many software applications are now designed to be licensed, delivered over a network (e.g., internet, intranet, etc.), and metered based on usage as opposed to being purchased and installed at an end-user's computing system. To take advantage of the capabilities of cloud computing, software applications can be built as a set of independent components that are composed to deliver a feature-set. These components can be made available in multiple formats, including: (i) private service components that can be custom developed and accessed privately using access credentials (e.g., security key, password, entity-specific identifier, license identifier, etc.), (ii) public service components that can be made freely available to the public, and (iii) cloud-specific infrastructure service components. Companies that develop software have been required to create new processes for delivering completed software to cloud computing systems to make the software available for end-users. For example, development and information technology operations (DevOps) practices have emerged to ensure that completed software is properly operating in cloud computing systems and can be accessed by end-users. Software operating in (e.g., hosted by) a cloud computing system for a set of one or more end-users may be referred to as an “environment” (also referred to as a “cloud environment”) and cloud computing techniques have enabled different versions of the same software to be operated in different environments for different use-cases. However, DevOps processes for generating, deploying, and/or managing environments can be complicated, error-prone, and risky. While standard DevOps practices for deploying software and managing environments exist, entities (e.g., organizations) still largely rely on custom-made software and business processes for enabling DevOps for their cloud software products.

In some cases, for a cloud computing system, data may be stored across many storage devices (e.g., non-volatile storage media such as disk storage) in a single storage array. Storage management techniques can ensure (i) data is correctly backed up to the storage array, (ii) outdated backups are removed regularly from the storage array, and (iii) data is indexed for retrieval from the storage array in case of a failure of any storage component in the storage array. In some cases, virtualization techniques may abstract storage space from hardware systems, thereby enabling the storage space be accessed by end-users as cloud storage. When storage is configured as a cloud storage resource, cloud service providers can add or remove drives, repurpose storage hardware, and respond to change without manually provisioning separate storage servers for every new initiative. In some cases, a cloud computing network can include physical wires, switches, routers, and other equipment, where virtual networks are created on top of the physical resources. A conventional cloud network configuration can include multiple subnetworks, each with varying levels of visibility. Cloud resources can permit the creation of virtual local area networks (VLANs) and can assign static and/or dynamic addresses as needed for all network resources. The cloud resources can be delivered to users over a network, such as the internet or an intranet, so that users can access cloud services and/or cloud applications remotely on demand. The above-described components of a cloud computing system can apply to public, private, and/or hybrid cloud infrastructure.

Conventionally, deployment of cloud infrastructure for related cloud services and/or cloud applications can include technical challenges. Cloud deployment can include several components that can require provisioning, configuration, installation, and tracking by an individual (e.g., system administrator) responsible for a cloud-based application (also referred to herein as “cloud application” and “application”). At a minimum, cloud infrastructure can require provisioning, configuration, and recordation. In some cases, custom software can be required to be installed and configured in an appropriate context for a cloud-based application corresponding to the cloud infrastructure. A network in which the cloud-based application operates can require hardening. In some cases, a domain name service (DNS) can be require configuration for the cloud-based application so that end-users can access the application using a web address (e.g., uniform resource locator (URL)) as opposed to an IP address. Further, deployment of cloud infrastructure can include business challenges. The individuals (e.g. systems administrators) that are responsible for deploying cloud-based applications can have virtually unlimited access to an entity's (e.g., a company's or an organization's) cloud environment. These individuals can operate with very little governance or control, and can easily make mistakes that put the entity at risk.

### SUMMARY

Improved systems and methods are desired that enable users to configure and deploy cloud-based applications including one or more private services, zero or more public services, and zero or more cloud infrastructure services to one or more environments. A cloud deployment platform may include the improved systems and method as described herein and may include a user interface (e.g., graphical user interface) made available to end users. In some cases, the user interface may be made accessible to end-users via a network (e.g., internet, intranet, etc.) and/or via an application operating at a client device operated by an end-user. The user interface of the cloud deployment platform may enable improved, user-friendly techniques for configuration and deployment of cloud-based applications, while maintaining customizability for the cloud-based applications based on the services linked to the cloud deployment platform. Further, the cloud deployment platform may automatically cause configuration and/or provisioning of the services included in a cloud-based application by communicating with third-party computing systems that provide and/or manage the services. In some cases, the cloud deployment platform may interface and/or otherwise communicate with computing system(s) of a cloud provider (also referred to as a “cloud vendor”) that is distinct and different from an entity providing the cloud deployment platform to end-users. For example, the cloud deployment platform may interface with services and cloud infrastructure derived from third-party cloud providers and registries.

Methods and systems for configuration of a cloud application are disclosed. In one aspect, the disclosure features a computer-implemented method for configuration of a cloud application. In one aspect, the method includes executing operations on one or more processors of one or more servers. The operations can include receiving, from a client device by a user interface, a first input including a selection of a first graphical icon for addition to a graphical canvas area of the user interface, where the first graphical icon is representative of a first component of a plurality of components configured to be included in the cloud application, where each of the plurality of components comprise one of: (i) a cloud infrastructure service of a plurality of cloud infrastructure services, (ii) a public containerized service of a plurality of public containerized services, or (iii) a private containerized service of a plurality of private containerized services. The operations can include receiving, from the client device by the user interface, a second input including a selection of a second graphical icon for addition to the graphical canvas area, where the second graphical icon is representative of a second component of the plurality of components. The operations can include causing display, based on the receipt of the first and second inputs, of the first graphical icon and the second graphical icon by the graphical canvas area, where a topology of the cloud application is configured based on the graphical canvas area. The operations can include receiving, from the client device by the user interface, a third input including a selection of a first graphical connection indicator between the first graphical icon and the second graphical icon for addition to the graphical canvas area. The operations can include causing display, based on the receipt of the third input, of the first graphical connection indicator between the first graphical icon and the second graphical icon by the graphical canvas area, where the first graphical connection indicator is representative of a network connection between the first component and the second component. The operations can include causing deployment of the cloud application to a cloud environment hosted by a cloud computing system, where the cloud application includes the topology indicated by the graphical canvas area.

Various embodiments of the method can include one or more of the following features. At least one of the first input, the second input, and the third input may be provided by a pointing device communicatively coupled to the client device. The user interface may be configured to be displayed by a display device communicatively connected by the client device. At least one of the plurality of cloud infrastructure services may be provided by at least one cloud infrastructure provider. The plurality of public containerized services may be provided by at least one public registry. The plurality of private containerized services may be provided by at least one private registry.

In some embodiments, receiving the first input including the selection of the first graphical icon for addition to the graphical canvas area of the user interface further can include receiving the first input including the selection of the first graphical icon from a graphical sidebar area of the user interface for addition to the graphical canvas area, where the selection of the first graphical icon can include moving the first graphical icon from a first position of the user interface included in the graphical sidebar area to a second position of the user interface included the graphical canvas area. Based on the receipt of the first and second inputs, the first graphical icon can be positioned at a first position of the user interface included in the graphical canvas area and the second graphical icon can be positioned at a second position of the user interface included in the graphical canvas area, the first position being different from the second position. The selection of the first graphical connection indicator can include one of (i) drawing the first graphical connection indicator in an area of the graphical canvas area between the first graphical icon and the second graphical icon, or (ii) connecting a first end of the first graphical connection indicator adjacent to the first graphical icon and connecting a second end of the first graphical connection indicator adjacent to the second graphical icon. The graphical canvas area can include a plurality of graphical icons representative of a subset of the plurality of components, where the plurality of graphical icons include at least the first graphical icon and the second graphical icon, and where the subset of the plurality of components includes at least the first component and the second component.

In some embodiments, operations can further include causing display, based on the receipt of the first input, of a graphical webform in the graphical canvas area, where the graphical webform includes a selection element for selecting one of a plurality of variables for configuration of the first component; receiving, from the client device by the user interface, a fourth input including a selection of a first variable of the plurality of variables; and storing the first variable. The operations can further include causing display, based on the receipt of the third input, of a graphical webform in the graphical canvas area, where the graphical webform includes a selection element for selecting one of a plurality of variables for configuration of the network connection between the first component and the second component; receiving, from the client device by the user interface, a fourth input including a selection of a first variable of the plurality of variables; and storing the first variable. The first graphical connection indicator can be configured to define (i) the first component as a source in the cloud application and (ii) the second component as a target in the cloud application. The operations can further include receiving, from the client device by the user interface, a fourth input configured to cause deployment of the cloud application to the cloud environment hosted by cloud computing system.

In some embodiments, the operations can further include receiving, from the client device by the user interface and after causing deployment of the cloud application to the cloud environment, a fourth input configured to cause decommissioning of the cloud environment hosted by the cloud computing system. The graphical canvas area can include at least one graphical connection indicator representative of a network connection between two components of the subset of the plurality of components, where the network connection between the two components of the subset of the plurality of components includes at least the network connection between the first component and the second component, and where the at least one graphical connection indicator includes the first graphical connection indicator. The topology of the cloud application can include at least (i) the subset of the plurality of components and (ii) the network connection between the first component and the second component. The fourth input can further include a selection of a schedule for causing deployment of the cloud application to the cloud environment, where the cloud application is configured to be deployed to the cloud environment based on the schedule.

In another aspect, the invention features a system for configuration of a cloud application. The system can include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

The above and other preferred features, including various novel details of implementation and combination of events, will now be more particularly described with reference to the accompanying figures and pointed out in the claims. It will be understood that the particular methods and systems described herein are shown by way of illustration only and not as limitations. As will be understood by those skilled in the art, the principles and features described herein may be employed in various and numerous embodiments without departing from the scope of any of the present inventions. As can be appreciated from foregoing and following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefore, and/or advantages thereof, is intended to assist the reader in understanding the present disclosure, and does not in any way limit the scope of any of the claims.

### BRIEF DESCRIPTION OF THE DRAWINGS

FIG. 1 shows a block diagram of a cloud deployment platform, according to some embodiments.

FIG. 2A shows a user interface of a cloud deployment platform, according to some embodiments.

FIG. 2B shows a user interface of a cloud deployment platform, according to some embodiments.

FIG. 2C shows a user interface of a cloud deployment platform, according to some embodiments.

FIG. 2D shows a user interface of a cloud deployment platform, according to some embodiments.

FIG. 3 shows a flowchart of a method for configuration of a cloud application via a cloud deployment platform, according to some embodiments.

FIG. 4 is a block diagram of an example computer system that may be used in implementing the technology described herein.

### DETAILED DESCRIPTION

The present disclosure is directed to methods and systems for configuration of cloud infrastructure, more specifically, methods and systems for deployment of cloud-based applications using a graphical user interface. As described herein, a cloud-based application can include and/or operate based on one or more of the following components:
A network topology in which the application runs, where the network topology indicates the communicative (e.g., network) connection(s) between components included in the application;
A set of zero or more infrastructure services provided by a cloud vendor (e.g. a relational database management system (RDBMS) cluster managed by Amazon Web Services (AWS)) configured to run in the application's network topology, referred to as “cloud infrastructure services”;
A set of zero or more services (e.g., containerized services) available via a public container registry (e.g., an in-memory database, used as a distributed, in-memory key-value database, cache, and message broker such as Redis provided by hub.docker.com), referred to as “public services”;
A set of one or more services (e.g., containerized services) that are available (e.g., only available) via a private container registry (e.g. a custom application programming interface (API) service stored in a privately controlled Artifactory repository), referred to as “private services”; and
Method(s) to schedule the execution of public and privates services across one or more computing devices communicatively connected with the network topology.

Using the cloud deployment platform, a user may configure a deployment of a cloud-based application by interacting with displayed graphical elements (e.g., graphical icons, indicators, and/or selection elements) of the user interface (e.g., via input/output (I/O) devices connected to a computing device). The cloud deployment platform can be capable of provisioning and/or causing provisioning of any and/or all of the various components listed above in a target cloud environment via communication with third-party computing systems that provide the components. Based on causing provisioning of networking and cloud infrastructure, the cloud deployment platform can deploy the containerized services to a scheduler configured to cause the services to run in a cloud environment, thereby making the application available to end-users for use.

A “container” and “containerized service” as described herein may refer to a unit of software that is a stand-alone, executable unit including necessary information to run a service and/or an application, such as computer-readable code, runtime tools, system tools, and/or system libraries. Containers can include defined variables (e.g., parameters) and can run a program, a workload, and/or a specific task. Cloud computing system(s) and related cloud infrastructure configurable by the cloud deployment platform as described herein may run one or more containers to provide applications to end users. In some cases, one or more services may be interconnected to form an application. In some cases, public and/or private services available for use with the cloud deployment platform may include containers that can be saved as container images. Such containers may be deployed as a part of a cloud application in an environment and container images may (i) be shared via the public and/or private registries as described herein and (ii) adhere to an Open Container Initiative (OCI) format. In some cases, public and private services may be made available via public and private registries, respectively. Some non-limiting examples of registries having public and/or private registry capabilities include: Docker Hub, Amazon Elastic Container Registry, Harbor, Azure Container Registry, GitHub Container Registry, Google Container Registry, and Red Hat Quay.

### Some Embodiments of a Cloud Deployment Platform

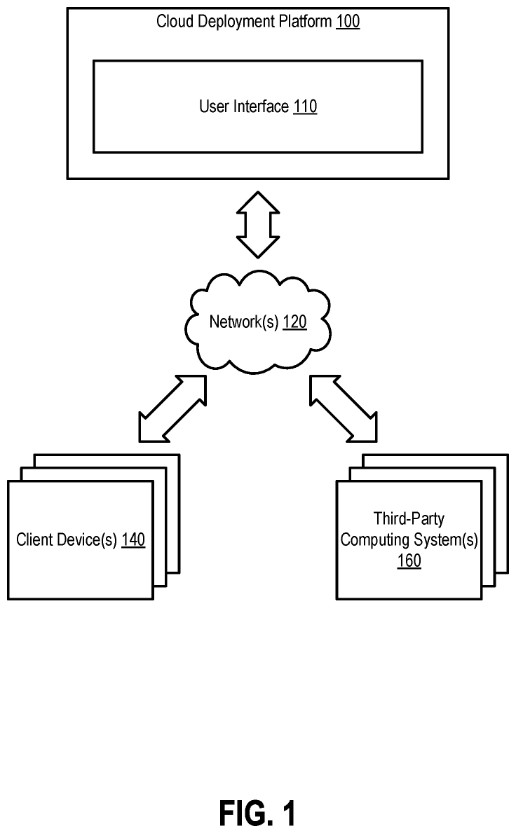

Referring to FIG. 1, an example of a cloud deployment platform 100 is shown, according to some embodiments. The cloud deployment platform 100 may operate on one or more computing devices (e.g., server computing devices) and may be accessible via one or more networks 120. The cloud deployment platform 100 may be communicatively connected to one or more client computing devices 140 and one or more third-party computing systems 160 via the one or more networks 120. In some cases, an end-user of the cloud deployment platform 100 may access and communicate with the cloud deployment platform 100 using a client computing device 140. In some cases, at least some of the one or more third-party computing systems 160 may include computing systems corresponding to third-party cloud providers as described herein. In some cases, at least some of the one or more third-party computing systems 160 may include computing systems corresponding to other entities, such as public container registry providers, private container registry providers, and/or cloud infrastructure providers. The third-party computing system(s) 160 may store and/or otherwise include private services, public services, and/or cloud infrastructure services available for configuration and deployment via the cloud deployment platform 100.

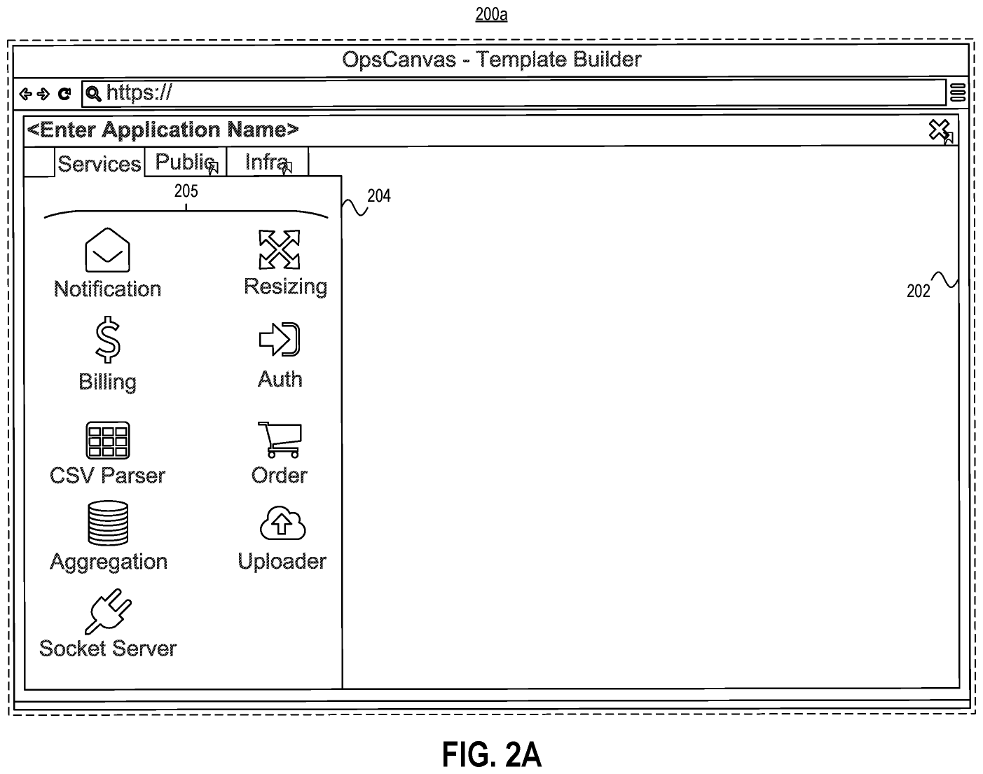

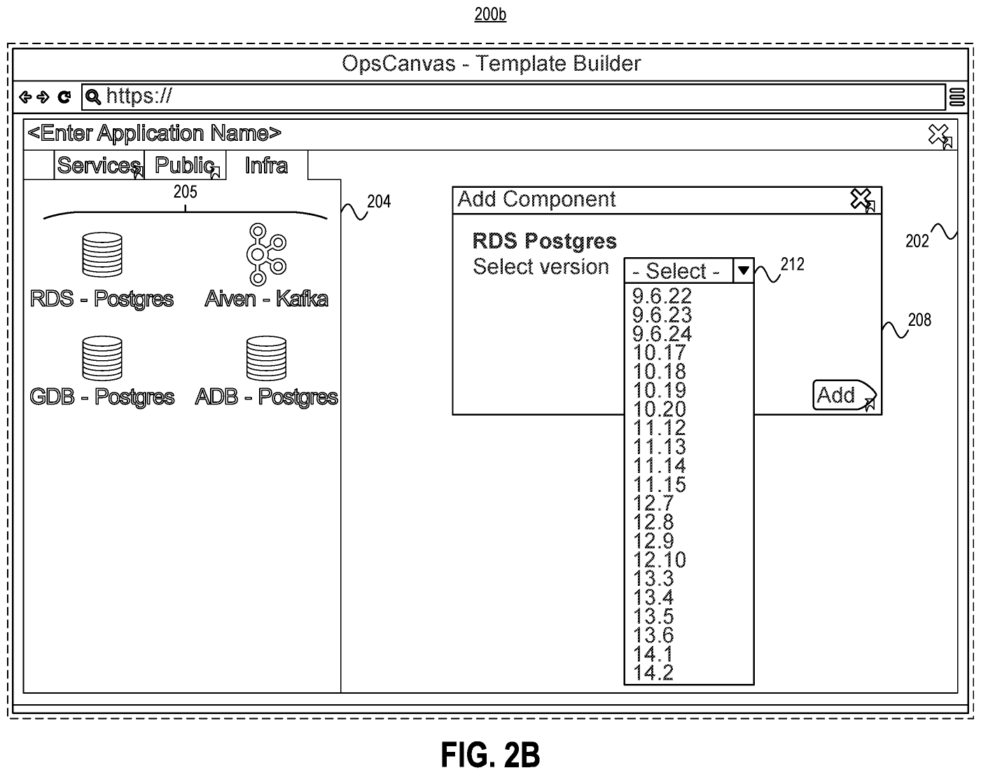

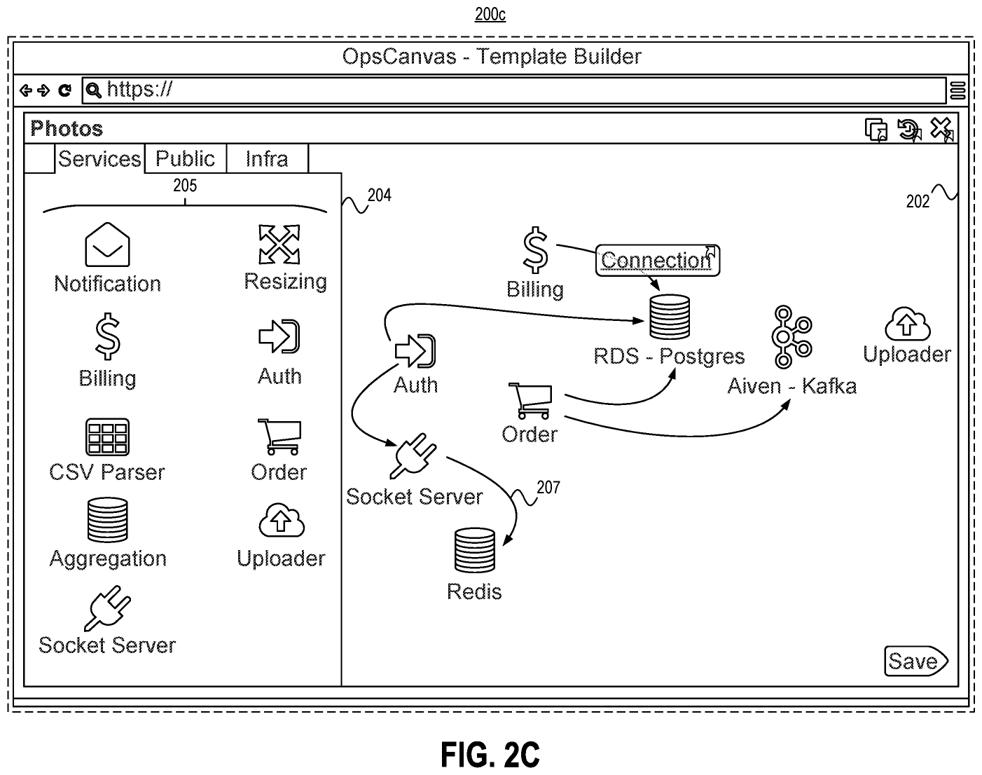

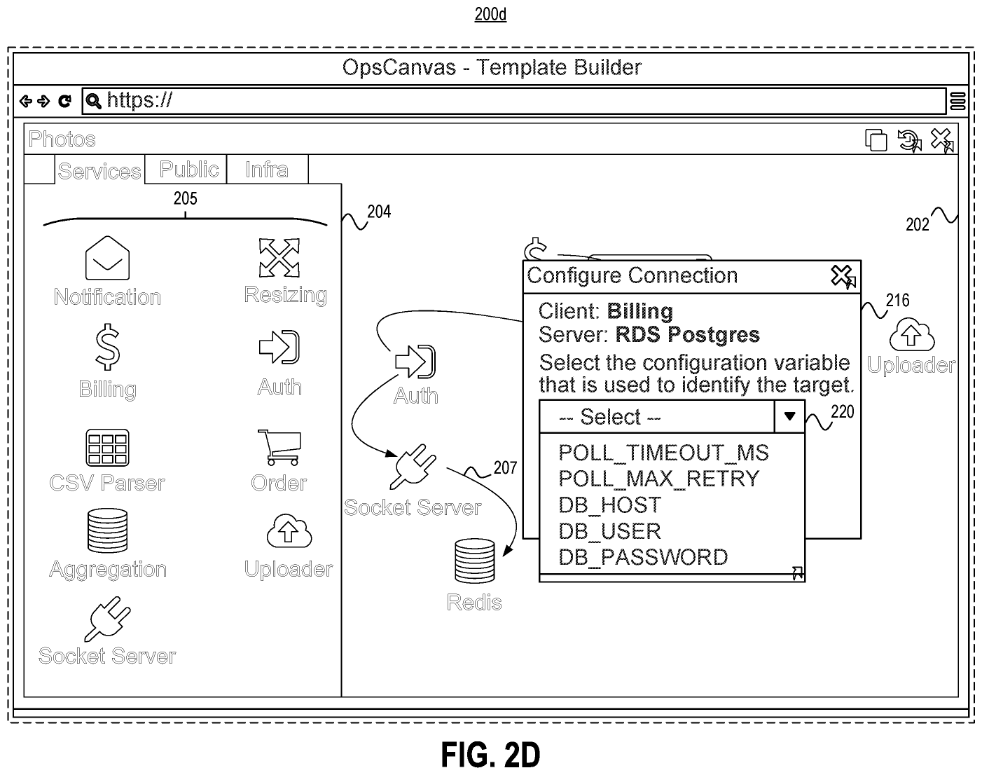

In some embodiments, the cloud deployment platform 100 may include a user interface 110 that is accessible via the one or more networks 120. In some cases, the user interface 110 may be a graphical user interface that can be displayed by a display device (e.g., connected to and/or included with a client computing device 140). For example, the user interface 110 may be available on a web page accessible via the one or more networks 120 (e.g., via the internet and/or an intranet) using a URL and web browser and may be displayed via a display device (e.g., screen) connected to a client computing device 140. Using the user interface 110, end-users accessing the cloud deployment platform 100 may configure a topology and cause deployment of cloud applications as described herein. To interact with the user interface 110, a client computing device 140 may provide one or more inputs to the user interface 110 that are sent to the cloud deployment platform 100 via the one or more networks 120. In some cases, an input may be provided by an input/output (I/O) device included in and/or communicatively connected to a client computing device 140. In some cases, an I/O device used to provide inputs to the cloud deployment platform may be a pointing device, such as a tracking camera mouse, computer mouse, touch sensitive element (e.g., a finger) applied to a touch screen, foot mouse, j-mouse, a joystick, a light pen, stylus, trackball, TrackPoint, touchpad, and/or keyboard. Some non-limiting examples of inputs provided by an I/O device connected to a client computing device 140 may be inputs to select, move (e.g., drag and drop), add, remove, and/or connect elements (e.g., graphical icons, indicators, and/or selection elements) graphically displayed via the user interface 110. Exemplary embodiments of the user interface 110 are described further below with respect to at least FIGS. 2A, 2B, 2C, and 2D.

In some embodiments, the third-party computing system(s) 160 can include one or more public container registries (also referred to herein as “public registries”) to which the cloud deployment platform 100 may be communicatively connected. A public container registry can include and make available a number of public services. A public service made available via a public container registry may be included in a cloud application configured and deployed to an environment via the cloud deployment platform 100. Some non-limiting examples of public services include To connect one or more public container registries to the cloud deployment platform 100, a user may provide one or more inputs to the user interface 110 to identify and associate the public container registry(ies) to the cloud deployment platform 100. As an example, a user (e.g., operating a client computing device 140 to access the user interface 110) may provide input(s) to a graphical, fillable webform displayed by the user interface 110, where the input(s) indicate identifying information for the public container registries that enable the cloud deployment platform 100 to communicate with the public container registries. In some cases, based the connection of a public registry to the cloud deployment platform 100, an entity managing the cloud deployment platform 100 (e.g., a system administrator) may be required to approve the connected public registry for use with the cloud deployment platform 100 for public services available via the connected public registry to be available for use within the cloud deployment platform 100. For example, a user may use public services included in the public registry for configuration of a cloud application via the user interface 110 only after the public registry has been approved by a system administrator of the cloud deployment platform 100.

In some embodiments, the third-party computing system(s) 160 can include one or more private container registries (also referred to herein as “private registries”) to which the cloud deployment platform 100 may be communicatively connected. A private container registry can include and make available a number of private services. In some cases, a private registry and included private services may only be accessible using access credentials, such as a security key, a password, an entity identifier, and/or a license identifier. Some non-limiting examples of private services can include a notification service for providing notifications, a resizing service for scaling cloud infrastructure, a billing service configuration of billing for access to a cloud application, an authentication service for authenticating access to a cloud application, a comma separated value (CSV) parser service for parsing and aggregating data from .csv files, an order service for processing and managing orders placed via a cloud application, an aggregation service for combing aggregated data, an upload service for enabling upload of data to a cloud application, and a socket server service for configuration and management of client/server communications. A private service made available via a private container registry may be included in a cloud application configured and deployed via the cloud deployment platform 100. To connect one or more private container registries to the cloud deployment platform 100, a user may provide one or more inputs to the user interface 110 to identify and associate the private container registry(ies) to the cloud deployment platform. As an example, a user (e.g., operating a client computing device 140 to access the user interface 110) may provide input(s) to a graphical, fillable webform displayed by the user interface 110, where the input(s) indicate identifying information for the private container registries that enable the cloud deployment platform 100 to communicate with the private container registries.

In some embodiments, the cloud deployment platform 100 may include a container registry crawler (also referred to herein as a “crawler”) configured to identity private services available in connected private registries. The container registry crawler may (i) enable connection of a private container registry to the cloud deployment platform 100 and (ii) retrieve identifying information for private service(s) stored in the private registry for use within the cloud deployment platform 100. A user may manage and enable the container registry crawler via the user interface 110 of the cloud deployment platform 100. To manage and/or enable the container registry crawler, a user with sufficient access privileges (e.g., such as cloud administrator privileges) can access the cloud deployment platform 100 and can access a “manage private registries” interface included in the user interface 110 of the cloud deployment platform 100. In some cases, to add a private container registry for use by the cloud deployment platform 100, a user may be required to provide access credentials to the cloud deployment platform 100. To connect a private container registries to the cloud deployment platform 100, a user may provide one or more inputs to the user interface 110 to identify and associate the private container registry to the cloud deployment platform 100 as described herein. In some cases, a type of identifying information for a private container registry provided via the user interface 110 may vary based on the cloud provider corresponding to the private registry. For example, identifying information for a private registry can include a unique identifier (e.g., a username or access key identifier), access credentials (e.g., a security key, a password, an entity identifier, a license identifier, etc.), and/or a registry uniform resource locator (URL).

In some embodiments, based on receiving identifying information for a private registry via the user interface 110, the cloud deployment platform 100 may verify that the received private registry information can be used to connect to a private registry. Based on verifying the received private registry information, the user interface 110 of the cloud deployment platform 100 may display a graphical prompt requesting that the user provide and/or otherwise select a crawl schedule for the crawler. The crawl schedule may be a frequency with which the crawler searches for private services available via the connected private registries. In some cases, the crawl schedule may be a frequency with which the crawler searches for and identifies private services newly available via the connected private registries. Via the user interface 110, a user may provide a custom crawl scheduled (e.g., every day, week, month, etc.) or select from a number of predefined crawl schedules. The crawler may search within connected private registries according to the selected crawl schedule to identify available private services. When the crawler identifies a private service (e.g., a new private service) a connected private registry, the crawler may identify and store metadata (e.g., identifying information) corresponding to the private service. The metadata may uniquely identify the private service and may be provided to the cloud deployment platform 100 for use in configuration and deployment of a cloud application as described herein. In some cases, the crawler may inspect the private service to identify labels defining the configuration variables of the private service, where definitions included in the labels of the configuration variables define a runtime behavior of the private service. In some cases, when the crawler identifies a definition of a label for a configuration variable of the private service, the crawler may provide the definition for storage by the cloud deployment platform 100. In some cases, the stored definition may be used by the cloud deployment platform 100 when configuring the private service in a cloud application topology.

In some embodiments, the third-party computing system(s) 160 can include cloud computing systems (e.g., including cloud infrastructure services) of one or more cloud infrastructure providers to which the cloud deployment platform 100 may be communicatively connected. Some non-limiting examples of cloud infrastructure services can include a distributed data streaming platform (e.g., Aiven Kafka), relational database service (RDS) engines (e.g., RDS Postgres), geodatabase (GDB) service engines (e.g., GDB Postgres), and autonomous and/or analytic database service (ADB) engines (e.g., ADB Postgres). A cloud computing system can include and make available cloud infrastructure services for use by applications and environments deployed via the cloud deployment platform 100. In some cases, cloud infrastructure services provided by a cloud infrastructure provider may be configured for use (e.g., for deployment purposes) within the cloud deployment platform 100. A configuration of cloud infrastructure services may be specific to the cloud infrastructure providers that are compatible with the cloud deployment platform 100. To request cloud infrastructure from specific cloud infrastructure providers, a user may interact with the user interface 110 of the cloud deployment platform 100 as described herein. In some cases, users of the cloud deployment platform 100 may request cloud infrastructure provider(s) and respective cloud infrastructure services to be added for use within the cloud deployment platform 100 via the user interface 110. The cloud deployment platform 100 may enable users to vote on cloud infrastructure services requested by other users for addition to use within the cloud deployment platform 100. For cloud infrastructure service(s) requested by a particular user, the user may review a number of votes received for the cloud infrastructure service that they suggested using the user interface 110, such that the user interface 110 can display the number of votes received in favor of adding the cloud infrastructure service. In some cases, users may review cloud infrastructure service requests and/or a status of cloud infrastructure service requests via the user interface 110. As an example, a status indicator for cloud infrastructure requests provided by the cloud deployment platform 100 and user interface 110 may be “suggested”, “in-progress”, and/or “available”.

In some embodiments, a user may configure a topology of a cloud application and deploy the cloud application for use via the user interface 110 of the cloud deployment platform 100. The topology of a cloud application may define and/or otherwise indicate (i) the public, private, and/or cloud infrastructure services (referred to herein as “components”) configured to be included in the cloud application, (ii) the communicative connections between the components, and (iii) definitions for variables corresponding to the components and/or communicative connections. A topology of a cloud application may be configured using a “template builder interface” included in the user interface 110 of the cloud deployment platform 100. For example, a user may graphically configure the topology of a cloud application by selecting and moving (e.g., dragging and dropping) a graphical icon representing a component (e.g., service) of the cloud application to a graphical area of the template builder interface referred to as a “canvas area” and “graphical canvas area”. Based on the user adding at least one graphical icon representative of a component of the cloud application to the canvas area, the user may add one or more graphical connection indicators (also referred to as “connections”) to the canvas area that (i) connect any combination of displayed graphical icons representative of components included on the canvas area and (ii) are indicative of a communicative relationship between the components. Each connection in the canvas area between graphical icons for components may represent communication (e.g., sending and/or receiving of data) between the components represented by the graphical icons over a network. Accordingly, a topology of graphical icons included in the canvas area and the connections between the graphical icons may be representative of components included in a cloud application and network communications between the components, respectively.

In some cases, a connection included in the canvas area can include and/or correspond to a webform (e.g., a fillable webform) that indicates variables(s) requiring configuration to enable a network connection between the components represented by the graphical icons. For example, a connection displayed on the canvas area can display an indication of variables(s) requiring user configuration to enable network communication between the components represented by the graphical icons. As configuration changes are applied to the canvas area (e.g., via user interaction with the canvas area), the configuration changes can be saved to durable storage on a computing device (e.g., server) hosting the cloud deployment platform 100 for retrieval at a later time. Referring to FIGS. 2A, 2B, 2C, and 2D, exemplary template builder interfaces 200a, 200b, 200c, and 200d (collectively referred to as a template builder interface 200) included in the user interface 110 of the cloud deployment platform 100 are shown. In some cases, the template builder interface 200 shown in FIGS. 2A-2D may be displayed in a web page accessible via a web browser operating on a client computing device 140. Additionally or alternatively, the template builder interface 200 may be displayed by an application installed and/or otherwise operating on a client computing device 140.

In some embodiments, as shown in FIGS. 2A-2D, the template builder interface 200 includes a canvas area 202 to which graphical icons 205 representative of components and/or connections 207 may be added and removed. The canvas area 202 may be a two-dimensional area of the template builder interface 200 including a number of distinct positions to which graphical icons 205 representative of components and connections representative of communicative (e.g., network) connections may be added as described herein. A topology of a cloud application may be defined according to the relationship between graphical icons 205 and/or connections 207 displayed on the canvas area 202, such that the cloud application can include the components and communicative connections represented in (e.g., defined by) the canvas area 202. As shown in FIGS. 2A-2D, the template builder interface 200 can include a sidebar 204 including graphical icons 205 that may be added to the canvas area 202, where the sidebar 204 has a tabbed interface including a number of tabs for selecting between categories of components for public services, private services, and cloud infrastructure services. A user may select between the categories by selecting a tab corresponding to a respective category on the sidebar 204. As an example, the template builder interface 200 includes a tabbed interface for selection of categories for private services (e.g., referred to as “Services” in FIG. 2A-2D), public services (e.g., referred to as “Public” in FIG. 2A-2D), and/or cloud infrastructure services (e.g., referred to as “Infra” in FIG. 2A-2D). In other embodiments of the template builder interface 200, a scrollable list, collapsible tree structure, or another display technique may be used in the sidebar 204 in place of a tabbed interface for listing the available categories of components and the components included therein. As shown in FIG. 2A, some non-limiting examples of graphical icons 205 representing private services available for addition to the canvas area 202 can include Notification, Resizing, Billing, Authentication, comma separated value (CSV) Parser, Order, Aggregation, Uploader, and Socket Server graphical icons 205 representative of respective Notification, Resizing, Billing, Authentication, comma separated value (CSV) Parser, Order, Aggregation, Uploader, and Socket Server private services.

In some embodiments, referring to FIG. 2A, a template builder interface 200a including a canvas area 202 is shown, where the canvas area 202 lacks any added graphical icons 205 and/or connections 207 that are representative of components and/or network connections included in a cloud application. In some cases, a user may add a graphical icon 205 from the sidebar 204 to the canvas area 202 by (i) selecting a graphical icon 205 in the sidebar 204 corresponding to a component and (ii) dragging the selected graphical icon 205 from a position in the sidebar 204 to a position in the canvas area 202 (e.g., using an I/O device connected to a client computing device 140). In other cases, a user may add a graphical icon 205 from the sidebar 204 to the canvas area 202 by selecting a graphical icon 205 in the sidebar 204 corresponding to a component, thereby causing the graphical icon 205 to be added to a position in the canvas area 202.

In some embodiments, as described herein, a user may select one or more graphical icons 205 and may add the selected graphical icons 205 to the canvas area 202 via the template builder interface 200. Referring to FIG. 2B, a template builder interface 200b including an example of a selection of a graphical icon 205 representative of a component from the sidebar 204 for addition to the canvas area 202 is shown. In the example of the template builder interface 200b, a user selected a graphical icon 205 representing a relational database service (RDS) Postgres cloud infrastructure service for addition to the canvas area 202. As shown in FIG. 2B, based on the template builder interface 200 receiving a selection to add a graphical icon 205 to the canvas area 202, the template builder interface 200b can display a webform 208 (e.g., fillable webform) for a variable of the component represented by the graphical icon 205 that requires user configuration. A user may provide a selection for the variable using a selection element 212 included in the webform 208. As shown in the example of FIG. 2B, for the graphical icon 205 representing an RDS Postgres cloud infrastructure service, a user can provide a selection of a version of the service using the selection element 212 that displays versions of the service that are available for selection. While the webform 208 is shown as including a version selection for a graphical icon 205 representing an RDS Postgres cloud infrastructure service, other component and corresponding variable types may be used by the cloud deployment platform 100 as described herein. In some cases, a component may not require configuration from a user for addition to the canvas area 202, such that selection of a graphical icon 205 representing a component for addition to the canvas area 202 causes the graphical icon 205 to be added to the canvas area 202 without display of a webform 208.

In some embodiments, based on a user adding one or more graphical icons 205 and/or connections 207 to the canvas area 202, the canvas area 202 may display a topology of a cloud application that can be provisioned and deployed to an environment using the cloud deployment platform 100. Referring to FIG. 2C, a template builder interface 200c including an example of a topology of a cloud application is shown. As shown in FIG. 2C, a cloud application can include one or more (e.g., a number of) graphical icons 205 and/or connections 207 that are representative of components and/or network connections configured to be included in a cloud application. A user may add graphical icons 205 (e.g., representative of public services, private services, and/or cloud infrastructure services) and connections 207 to the canvas area 202 shown in FIG. 2C as described herein. For example, as shown in the template builder interface 200c, a user may add respective connections 207 from graphical icons 205 representative of Billing, Order, and Authentication private services to a graphical icon 205 representative of an RDS Postgres cloud infrastructure service. In some cases, a user may modify existing graphical icons 205 and connections 207 displayed in the canvas area 202. In some cases, a connection 207 between graphical icons 205 can indicate a direction of communication (e.g., in a source-target/client-server relationship), where a first graphical icon 205 represents a component that operates as a source (or client) and a second graphical icon 205 represents a component that operates as a target (or server). For example, according to the topology of the cloud application as shown in FIG. 2C, a Socket Server private service may initially send data to a Redis service and the Redis service may receive the data from the Socker Server private service based on the connection 207 between the graphical icons 205 representing the Socket Server private service and the Redis service. After the Socket Server private service sends data to the Redis service, data may communicated unidirectionally (e.g., from source/client to target/server) or bidirectionally between the services. In some cases, the direction in which a connection 207 is added between first and second graphical icons 205 can define which of the components represented by the first and second icons operate as the source and target in the network communication represented by the connection. For example, when an end of the connection 207 is initially added closest to a first graphical icon 205 relative to a second graphical icon, the component represented by the first graphical icon 205 may be defined as the source and the second graphical icon 205 may be defined as the target when a second end of the connection 207 is added to the canvas area 202 closest to the second graphical icon 205 and between the first and second graphical icons.

In some embodiments, via the template builder interface 200, a user may add a connection 207 between graphical icons 205 included the canvas area 202. As an example, a user may provide a selection to add a connection 207 between graphical icons 205 by (i) selecting and adding a graphical indicator (e.g., line) to the canvas area 202 and (ii) dragging and dropping ends of the graphical indicator between a pair of graphical icons 205 to visually connect the graphical icons 205 in the canvas area 202. Referring to FIG. 2D, a template builder interface 200d including an example of configuration of a connection 207 between graphical icons 205 for addition to the canvas area 202 is shown. As shown in FIG. 2D, based on the template builder interface 200d receiving a selection to add a connection 207 between graphical icons, the template builder interface 200d can display a webform 216 (e.g., fillable webform) for a variable of the connection 207 requiring user configuration. A user may provide a selection for the variable using a selection element 220 included in the webform 216. As shown in the example of FIG. 2D, for a source (or client) graphical icon 205 representative of a Billing service and a target (or server) graphical icon 205 representative of an RDS Postgres cloud infrastructure service, a user can provide a selection of a variable identifying the target of the connection 207 using the selection element 220 that displays the configuration variables available for selection. While webform 216 is shown as including configuration variables used to identify a target for a source graphical icon 205 representative of a Billing service and the target graphical icon 205 representative of an RDS Postgres cloud infrastructure service, other connections 207 and corresponding variable types may be used by the cloud deployment platform 100 as described herein. In some cases, connections 207 may not require configuration from a user for addition to the canvas area 202, such that selection of a connection 207 for addition to the canvas area 202 causes the connection 207 to be added to the canvas area 202 without display of a webform 216. In some cases, variable(s) of a connection 207 may be required to be configured for the corresponding cloud application to be deployed for operation in an environment.

In some embodiments, as described herein, a cloud application (also referred to herein as an application) includes one or more components and/or network connections that can be deployed in an environment. A user of the cloud deployment platform 100 may configure and deploy an application via the user interface 110 of the cloud deployment platform 100, where graphical icons 205 and/or connections included in the canvas area 202 of the template builder interface 200 are representative of components and/or network connections included in the cloud application. Based on receiving (e.g., via the user interface 110) a user input including a selection to deploy an application to run in an environment, the cloud deployment platform 100 may automatically provision and/or cause provisioning of the cloud infrastructure service(s) represented by graphical icon(s) included in the canvas area 202 corresponding to the application and configured using the template builder interface 200 as described herein. In some cases, provisioning the cloud infrastructure services to deploy the application can include causing provisioning of required network(s) (e.g., including virtual private clouds (VPCs), public subnets, and/or private subnets) used to establish communications between services included in the application. The cloud deployment platform 100 may send and receive communications to/from third-party computing systems 160 that provide cloud infrastructure services to cause provisioning of the services. The components and network connections of the deployed application may be based on (e.g., defined by) the variable(s) selected by a user via the template builder interface 200 (e.g., using displayed webforms such as the webform 208 and webform 216).

In some embodiments, the cloud deployment platform 100 may display one or more webforms via the user interface 110 to collect metadata (e.g., corresponding to an application) from a user of the cloud deployment platform 100. Metadata for an application may include an application name, a description of the application, and an identifier identifying the user causing deployment of the application. In some cases, the cloud deployment platform 100 may display one or more prompts querying the user for additional metadata (e.g., metadata useful for reporting and analytics). In some cases, when a user modifies an application's metadata via the user interface 110, the user interface 110 may display a graphic (e.g., diagram) including indications of graphical icons 205 representative of each component included in the application. A user may select a displayed graphical icon 205 included in the graphic to cause display of the template builder interface 200, where the template builder interface 200 displays graphical icons 205 and/or connections 207 for the application as described herein.

In some embodiments, a user may publish an application for deployment using the cloud deployment platform 100. For an application to be available for deployment, the application may be required to be published. In some cases, only users having sufficient permissions (e.g., a “Publish Application” permission) are able to publish applications for deployment via the cloud deployment platform 100. When a user without sufficient permission saves an application in the cloud deployment platform 100 (e.g., via an input including a selection at the user interface 110), the cloud deployment platform 100 may send or cause sending of a notification (e.g., short message service (SMS) message, email message, social media message, notification, etc.) to one or more users having sufficient permissions, such that the users with sufficient permissions can access the cloud deployment platform 100 and publish the application for deployment.

In some embodiments, when a user having sufficient permissions is notified (e.g., by receiving a notification) of an application pending publication, the user may access the user interface 110 of the cloud deployment platform 100 and the user interface 110 may display (i) indications of applications that are published for deployment and (ii) indications of applications that are pending approval for publishing. The user may provide an input at the user interface 110 including a selection to publish pending applications, such that the applications are available for deployment. In some cases, via the user interface 110, a user can provide an input including a selection to retract an application from publication, such that the application can no longer be deployed to an environment hosted by a cloud computing system. A deployed environment that is based on (e.g., dependent on) a retracted application may continue to run, and can be terminated, but not updated via the user interface 110 of the cloud deployment platform 100.

In some embodiments, a user may configure a collection of applications (referred to as a “platform”) using the cloud deployment platform 100. The cloud deployment platform 100 may track and display a particular user's platform as a respective collection of applications deployed via the cloud deployment platform that are associated with (e.g., deployed by) the user. In some cases, the cloud deployment platform 100 may track and display metadata corresponding to a user's platform as described herein with respect to tracking metadata for a user's application(s).

In some embodiments, the user interface 110 of the cloud deployment platform 100 can enable users to deploy a cloud environment (also referred to herein as an environment). A deployed cloud environment may include one or more deployed application(s) associated with (i) a particular user of the cloud deployment platform 100 or (ii) a group of users corresponding to an entity (e.g., organization, customer of the cloud deployment platform, etc.) that uses the cloud deployment platform 100. The cloud deployment platform 100 may launch a new environment based on one or more lifecycle rules. In some cases, lifecycle rules may define timing information for deploying and running an environment on a cloud computing system (e.g., included in the third-party computing systems 160). Some non-limiting examples of lifecycle rules can include: launch environment immediately and operate indefinitely, launch environment immediately and decommission the environment after operating for a selected amount of time; and a schedule for launching and decommissioning the environment. In some cases, only users of the cloud deployment platform 100 with sufficient permissions (e.g., a “launch environment” permission) can execute and cause deployment of an environment to a cloud computing system. When a user without sufficient permission configures deployment of an environment, the cloud deployment platform 100 may send or cause sending of a notification (e.g., short message service (SMS) message, email message, social media message, etc.) to one or more users having the sufficient permissions, such that the users having the sufficient permissions can access the cloud deployment platform 100 and launch the environment for deployment to a cloud computing system.

In some embodiments, the user interface 110 of the cloud deployment platform 100 may enable user to view and analyze environment(s) that that have been deployed to cloud computing system(s) for operation using the cloud deployment platform 100. In some cases, the cloud deployment platform 100 may aggregate statistics corresponding to cloud environments deployed using the cloud deployment platform 100. Some non-limiting examples of aggregated statistics can include a number of deployments (e.g., applications available for deployment), number of environments, number of components included in the environments, hours of time running the environments, and length of time to deploy an application. In some cases, statistics may be aggregated on a per-user basis and/or a per-entity basis for a group of users corresponding to an entity that uses the cloud deployment platform 100. In some cases, the cloud deployment platform 100 may generate a cloud infrastructure bill of materials (BoM) that describes and/or otherwise indicates cloud infrastructure services (e.g., services corresponding to a third-party cloud provider) that have been launched for a cloud environment, an amount of time that the cloud infrastructure services have operated, and a cost for operating the cloud infrastructure services. In some cases, the cloud deployment platform 100 may generate a cloud infrastructure BoM as described herein for an individual application. A user may access, generate, review, and download a cloud infrastructure BoM via the user interface 110 of the cloud deployment platform 100.

In some embodiments, when a user having sufficient permissions is notified (e.g., by receiving a notification) of an environment pending deployment, the user may access the user interface 110 of the cloud deployment platform 100 and the user interface 110 may display indications of environments that are pending deployment. The user may provide an input at the user interface 110 including a selection to execute a pending deployment to launch the environment for hosting by a cloud computing system. In some cases, via the user interface 110, a user can provide an input including a selection to retract an environment from deployment, such that the cloud deployment platform 100 will tear down the running environment to decommission the corresponding cloud computing system infrastructure, thereby making the environment unavailable to end-users.

In some embodiments, the cloud deployment platform 100 may generate a report indicative of an application and associated deployments for the application. The report may be accessible at the user interface 110 of the cloud deployment platform 100. A user may cause generation of the report by providing an input at the user interface 110 of the cloud deployment platform 100. An example of the report may include an indication of a user that scheduled a deployment of the application, a start time for the deployment, a decommission time for the deployment, an approver of the deployment, and/or pointer (e.g., URL or hyperlink) to a BoM for the deployment.

In some embodiments, the cloud deployment platform 100 may track changes of application metadata and/or a related service configuration (e.g., including configuration of service(s) via the template builder interface 200). Information indicative of changes to application metadata and/or a service configuration may be accessible at the user interface 110 of the cloud deployment platform 100. An example of the tracked changes may include a date of a change, an indication of a user that made the change, indications of the values of the metadata fields before and after the change, and/or a textual description of service configuration changes.

In some embodiments, the cloud deployment platform 100 may store a listing of configuration variables supported by components represented by graphical icons 205 of an application (e.g., configured via the template builder interface 200). A list of configuration variables may be generated and stored on a per-component basis. In some cases, a user may generate a list of configuration variables for a particular component corresponding to a graphical icon 205 selected for addition to the canvas area 202 using the template builder interface 200. The user may provide one or more inputs to the user interface 110 of the cloud deployment platform 100 to identify the name, type, and/or validation expression for the configuration variables that are used to configure the component represented by the graphical icon. For example, a user may provide inputs to a webform displayed by the template builder interface 200 to identify the name, type, and/or validation expression for the configuration variables that are used to configure the component represented by the graphical icon. In some cases, to generate the list of configuration variables, a user may provide one or more inputs at the user interface 110 to a label for a public or private service (e.g., a docker container) with the key “io.opscanvas.variables” and a value that conforms to the listed JSON schema included in Table 1.

```
TABLE 1
{
      ″$schema″: ″https://json-schema.org/draft/2020-12/schema″,
      ″$id″: ″http://example.com/example.json″,
      ″title″: ″Component Variable Configuration″,
      ″type″: ″array″,
      ″default″: [ ],
      ″items″: {
            ″type″: ″object″,
            ″default″: { },
            ″title″: ″A Variable″,
            ″required″: [ ″name″, ″type″ ],
            ″properties″: {
                  ″name″: {
                  ″type″: ″string″,
                  ″default″: ″″,
                  ″title″: ″The variable Name″,
                  ″examples″: [
                        ″jdbcUrl″,
                        ″intervalMs″,
                        ″maxRetries″
                  ]
                  },
                  ″type″: {
                  ″type″: ″string″,
                  ″enum″: [
                        ″String″,
                        ″Int″,
                        ″Float″,
                        ″Bool″,
                        ″Url″,
                        ″UUID″,
                        ″RegEx″
                  ],
                  ″default″: ″″,
                  ″title″: ″The variable type″,
                  ″examples″: [ ″String″ ]
                  },
                  ″validationExpr″: {
                  ″type″: [ ″string″, ″null″ ],
                  ″default″: null,
                  ″title″: ″Regex validation expression″,
                  ″examples″: [ ″\hat{ }\\d{3}-\\d{2}-\\d{4}$″ ]
                  }
            },
            ″examples″: [
                  {
                        ″name″: ″foo″,
                        ″type″: ″String″
                  }
            ]
      },
      ″required″: [
            ″name″,
            ″type″
      ]
}
```

As shown in Table 1, supported variable types for configuration variables can include “String”, “Int”, “Float”, “Bool”, “Url”, “UUID”, and “RegEx”.

In some embodiments, the cloud deployment platform 100 may enable users to create service variations, where a service variation is a copy of a particular application including one or more components having a different type. As an example, for an application that is configured to use a database as a cloud infrastructure service, a user can create a service variation where the same database is instead configured as a public service. In some cases, only users having sufficient permissions (e.g., a “Publish Application” permission) are able to publish service variations, such that the variations are available for deployment. When a user without sufficient permission saves a service variation in the cloud deployment platform 100 (e.g., via a selection at the user interface 110), the cloud deployment platform 100 may send a notification to one or more users with sufficient permissions, such that the users with sufficient permissions can access the cloud deployment platform 100 and publish the service variation for deployment.

### Some Embodiments of a Method for Cloud Application Deployment

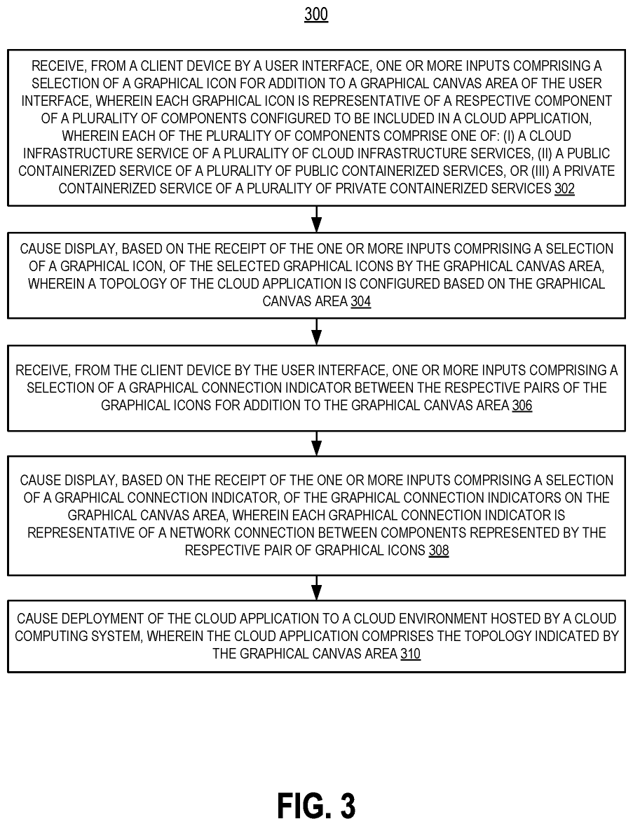

In some embodiments, the cloud deployment platform 100 may be used to configure a topology of a cloud application, including components configured to be included in the cloud application, network connections between the components, and selections of configuration variables for the components and the connections that define runtime behavior of the application. Accordingly, the cloud deployment platform 100 as described herein may execute a method for configuration of a cloud application. The method may be used to configure the composition of a cloud application and cause deployment to an environment operating in a cloud computing system external to the cloud deployment platform. The method may be performed periodically and/or on-demand, such that an application can be configured and re-configured as desired via a user interface 110 of the cloud deployment platform 100. Referring to FIG. 3, a flowchart of a method 300 for configuration of a cloud application is shown, according to some embodiments. The method 300 may be suitable for configuration of components, network connections, and configuration variables to be included a cloud application. Using the cloud deployment platform 100 (e.g., via user input originating from a client computing device 140), the resulting application may be published for availability for deployment and then deployed in an environment operating on and/or otherwise hosted by a cloud computing system.

For simplicity, the following paragraphs describe steps 302-310 of the method 300 with reference to configuration of a single application. However, one of ordinary skill in the art will appreciate that steps 302-310 may be performed in parallel and/or repeated for any number of applications, such that more than one application and/or the same application may be configured and/or re-configured via the method 300. The method 300 may be performed, for example, by one or more processors of one or more servers that operate and/or host the cloud deployment platform 100.

At step 302, a cloud deployment platform (e.g., cloud deployment platform 100) can receive, from a client device (e.g., client computing device 140) by a user interface (e.g., user interface 110 including a template builder interface 200), one or more inputs including one or more selections of graphical icons for addition to positions of a graphical canvas area (e.g., canvas area 202) of the user interface. Each of the graphical icons may be representative of a respective component of a number of components that may be selected for inclusion in the cloud application, where a component may be configured to be included in the cloud application when added to and included in the graphical canvas area. Each component of the number of components can be one of: (i) a cloud infrastructure service of a plurality of cloud infrastructure services, (ii) a public containerized service of a plurality of public containerized services, or (iii) a private containerized service of a plurality of private containerized services. In some cases, with respect to step 302, the cloud deployment platform can receive, from the client device by the user interface, a first input of the one or more inputs that includes a selection of a first graphical icon for addition to a first position in the graphical canvas area of the user interface, where the first graphical icon is representative of a first component of a plurality of components configured to be included in the cloud application. In some cases, with respect to step 302, the cloud deployment platform can receive, from the client device by the user interface, a second input of the one or more inputs that includes a selection of a second graphical icon for addition to a second position in the graphical canvas area of the user interface, where the second graphical icon is representative of a second component of a plurality of components configured to be included in the cloud application.

In some embodiments, the user interface is configured to be displayed by a display device communicatively connected by the client device. In some cases, receiving the first input further includes receiving the first input including the selection of the first graphical icon from a graphical sidebar area of the user interface for addition to the graphical canvas area, where the selection of the first graphical icon includes moving the first graphical icon from a first position of the user interface included in the graphical sidebar area to a second position of the user interface included the graphical canvas area. In some cases, based on the receipt of the first and second inputs, the first graphical icon is positioned at a first position of the user interface included in the graphical canvas area and the second graphical icon is positioned at a second position of the user interface included in the graphical canvas area, the first position being different from the second position.

At step 304, the cloud deployment platform can cause display, based on the receipt of the one or more inputs including selections of graphical icons for addition to the graphical canvas area, of the one or more graphical icons by the graphical canvas area. A topology of the cloud application is configured based on (e.g., defined by) the graphical canvas area (e.g., graphical icons and graphical connection indicators included in the graphical canvas area and their relationships therein), such that the graphical canvas area defines the components and network connections configured to be included in the cloud application. In some cases, with respect to step 304, the cloud deployment platform can cause display, based on the receipt of the first and second inputs, of the first graphical icon and the second graphical icon by the graphical canvas area.

At step 306, the cloud deployment platform can receive, from the client device by the user interface, one or more inputs including one or more selections of graphical connection indicators between respective pairs of displayed graphical icons for addition to the graphical canvas area. Each of the graphical connection indicators may be representative of a network connection between the respective pair of components represented by the respective pair of displayed graphical icons corresponding to the pair of components. In some cases, with respect to step 306, the cloud deployment platform can receive a third input of the one or more inputs that includes a selection of a first graphical connection indicator between the first graphical icon and the second graphical icon for addition to the graphical canvas area. The first graphical connection indicator can be representative of a network connection between the first component and the second component.

In some embodiments, the selection of the first graphical connection indicator includes one of (i) drawing the first graphical connection indicator in an area of the graphical canvas area between the first graphical icon and the second graphical icon, or (ii) connecting a first end of the first graphical connection indicator adjacent to the first graphical icon and connecting a second end of the first graphical connection indicator adjacent to the second graphical icon. With respect to the first and second graphical icons, the first end of the first graphical connection indicator may be closest to the first graphical icon and the second end of the second graphical connection indicator may be closest to the second graphical icon

At step 308, the cloud deployment platform can cause display, based on the receipt of the one or more inputs including selections of graphical connection indicators for addition to the graphical canvas area, of the one or more graphical connection indicators by the graphical canvas area. In some cases, with respect to step 308, the cloud deployment platform cause display, based on the receipt of the third input, of the first graphical connection indicator between the first graphical icon and the second graphical icon by the graphical canvas area, where the first graphical connection indicator is representative of a network connection between the first component and the second component.

At step 310, the cloud deployment platform can cause deployment of the cloud application to a cloud environment hosted by a cloud computing system, where the cloud application includes the topology indicated by the graphical canvas area. The cloud application may include the components and/or communicative connections defined via the graphical icons and connections included in the graphical canvas area via user inputs. In some cases, the runtime behavior of the cloud application may be defined via the selections of configuration variables (e.g., using webforms and selection elements) for the components and/or communicative connections represented by the graphical icons and connections included in the graphical canvas area. In some cases, causing deployment of the cloud application may include causing provisioning of cloud infrastructure services and/or other services (e.g., public and private services) configured to be included in the cloud application. To cause deployment of the cloud application, the cloud deployment platform may send and/or receive one or more communications to third party computing system(s) (e.g., third-party computing systems 160) that provide and/or manage the components configured to be included in the cloud application. The communications may include instructions to deploy the services according to a schedule defined for the cloud application (e.g., via the user interface 110).

In some embodiments, the method 300 can further include additional and/or alternative steps and features (not shown in FIG. 3). In some cases, at least one of the first input, the second input, and the third input are provided by a pointing device communicatively coupled to the client device. In some cases, the client device may include one or more client devices, such that the first input, the second input, and the third input can be provided by the same client device and/or multiple different client devices. In some cases, at least one of the plurality of cloud infrastructure services are provided by at least one cloud infrastructure provider. In some cases, the plurality of public containerized services are provided by at least one public registry. In some cases, the plurality of private containerized services are provided by at least one private registry. The graphical canvas area can include a plurality of graphical icons representative of a subset of the plurality of components, where the plurality of graphical icons includes at least the first graphical icon and the second graphical icon, and where the subset of the plurality of components includes at least the first component and the second component. The graphical canvas area can include at least one graphical connection indicator representative of a network connection between two components of the subset of the plurality of components, where the network connection between the two components of the subset of the plurality of components includes at least the network connection between the first component and the second component, and where the at least one graphical connection indicator includes the first graphical connection indicator.

In some embodiments, for the method 300, the cloud deployment platform can further cause display, based on the receipt of the first input, of a graphical webform in the graphical canvas area, where the graphical webform includes a selection element for selecting one of a plurality of variables for configuration of the first component. The cloud deployment platform can further receive, from the client device by the user interface, a fourth input including a selection of a first variable of the plurality of variables, and storing the first variable. In some cases, the cloud deployment platform can further cause display, based on the receipt of the third input, of a graphical webform in the graphical canvas area, where the graphical webform includes a selection element for selecting one of a plurality of variables for configuration of the network connection between the first component and the second component. The cloud deployment platform can further receive, from the client device by the user interface, a fourth input includes a selection of a first variable of the plurality of variables, and storing the first variable. In some cases, the first graphical connection indicator is configured to define (i) the first component as a source in the cloud application and (ii) the second component as a target in the cloud application. The cloud deployment platform can further receive, from the client device by the user interface, a fourth input configured to cause deployment of the cloud application to the cloud environment hosted by cloud computing system.

In some embodiments, cloud deployment platform can further receive, from the client device by the user interface and after causing deployment of the cloud application to the cloud environment, a fourth input configured to cause decommissioning of the cloud environment hosted by the cloud computing system. The topology of the cloud application can include at least (i) the subset of the plurality of components, (ii) the network connection between the first component and the second component, and/or (iii) selection(s) of variable(s) for configuration of the subset of plurality of components and the network connection between the first and second components. In some cases, the fourth input can further include a selection of a schedule for causing deployment of the cloud application to the cloud environment, where the cloud application is configured to be deployed to the cloud environment based on the schedule.

### Computer-Based Implementations

In some examples, some or all of the processing described above can be carried out on a personal computing device, on one or more centralized computing devices, or via cloud-based processing by one or more servers. In some examples, some types of processing occur on one device and other types of processing occur on another device. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

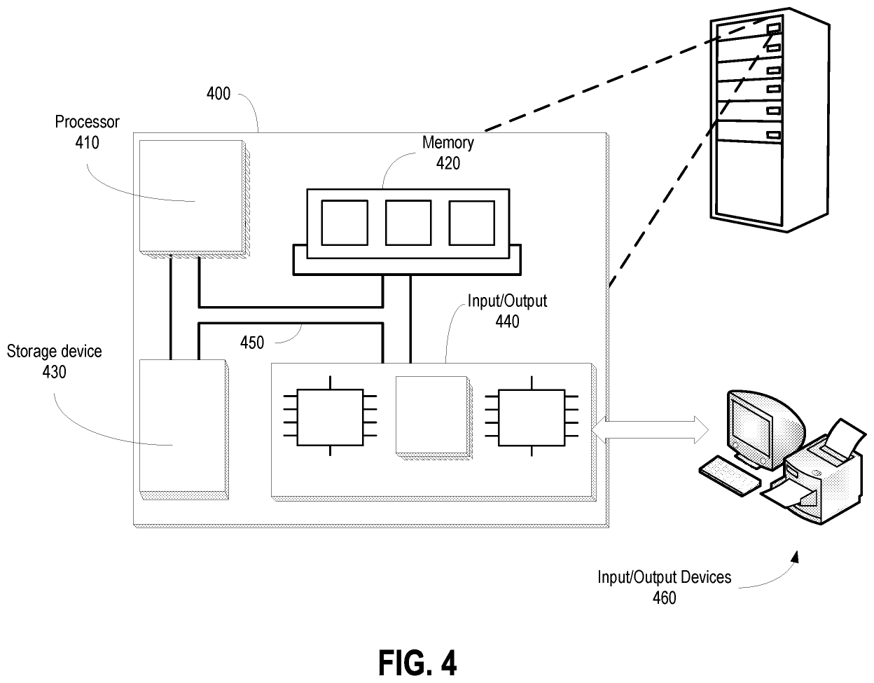

FIG. 4 is a block diagram of an example computer system 400 that may be used in implementing the technology described in this document. General-purpose computers, network appliances, mobile devices, or other electronic systems may also include at least portions of the system 400. The system 400 includes a processor 410, a memory 420, a storage device 430, and an input/output device 440. Each of the components 410, 420, 430, and 440 may be interconnected, for example, using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430.

The memory 420 stores information within the system 400. In some implementations, the memory 420 is a non-transitory computer-readable medium. In some implementations, the memory 420 is a volatile memory unit. In some implementations, the memory 420 is a non-volatile memory unit.

The storage device 430 is capable of providing mass storage for the system 400. In some implementations, the storage device 430 is a non-transitory computer-readable medium. In various different implementations, the storage device 430 may include, for example, a hard disk device, an optical disk device, a solid-date drive, a flash drive, or some other large capacity storage device. For example, the storage device may store long-term data (e.g., database data, file system data, etc.). The input/output device 440 provides input/output operations for the system 400. In some implementations, the input/output device 440 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 460. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 430 may be implemented in a distributed way over a network, such as a server farm or a set of widely distributed servers, or may be implemented in a single computing device.

Although an example processing system has been described in FIG. 4, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A computer-implemented method for configuration of a cloud application, the method comprising:
executing operations on one or more processors of one or more servers, the operations comprising:
receiving, from a client device by a user interface, a first input comprising a selection of a first graphical icon for addition to a graphical canvas area of the user interface, wherein the first graphical icon is representative of a first component of a plurality of components configured to be included in the cloud application, wherein each of the plurality of components comprise one of: (i) a cloud infrastructure service of a plurality of cloud infrastructure services, (ii) a public containerized service of a plurality of public containerized services, or (iii) a private containerized service of a plurality of private containerized services;
receiving, from the client device by the user interface, a second input comprising a selection of a second graphical icon for addition to the graphical canvas area, wherein the second graphical icon is representative of a second component of the plurality of components;
causing display, based on the receipt of the first and second inputs, of the first graphical icon and the second graphical icon by the graphical canvas area, wherein a topology of the cloud application is configured based on the graphical canvas area;
receiving, from the client device by the user interface, a third input comprising a selection of a first graphical connection indicator between the first graphical icon and the second graphical icon for addition to the graphical canvas area;
causing display, based on the receipt of the third input, of the first graphical connection indicator between the first graphical icon and the second graphical icon by the graphical canvas area, wherein the first graphical connection indicator is representative of a network connection between the first component and the second component; and
causing deployment of the cloud application to a cloud environment hosted by a cloud computing system, wherein the cloud application comprises the topology indicated by the graphical canvas area.

2. The method of claim 1, wherein at least one of the first input, the second input, and the third input are provided by a pointing device communicatively coupled to the client device.

3. The method of claim 1, wherein the user interface is configured to be displayed by a display device communicatively connected by the client device.

4. The method of claim 1, wherein at least one of the plurality of cloud infrastructure services are provided by at least one cloud infrastructure provider.

5. The method of claim 1, wherein the plurality of public containerized services are provided by at least one public registry

6. The method of claim 1, wherein the plurality of private containerized services are provided by at least one private registry.

7. The method of claim 1, wherein the receiving the first input comprising the selection of the first graphical icon for addition to the graphical canvas area of the user interface further comprises:
receiving the first input comprising the selection of the first graphical icon from a graphical sidebar area of the user interface for addition to the graphical canvas area, wherein the selection of the first graphical icon comprises moving the first graphical icon from a first position of the user interface included in the graphical sidebar area to a second position of the user interface included the graphical canvas area.

8. The method of claim 1, wherein based on the receipt of the first and second inputs, the first graphical icon is positioned at a first position of the user interface included in the graphical canvas area and the second graphical icon is positioned at a second position of the user interface included in the graphical canvas area, the first position being different from the second position.

9. The method of claim 1, wherein the selection of the first graphical connection indicator comprises one of:
(i) drawing the first graphical connection indicator in an area of the graphical canvas area between the first graphical icon and the second graphical icon, or
(ii) connecting a first end of the first graphical connection indicator adjacent to the first graphical icon and connecting a second end of the first graphical connection indicator adjacent to the second graphical icon.

10. The method of claim 1, wherein the graphical canvas area comprises a plurality of graphical icons representative of a subset of the plurality of components, wherein the plurality of graphical icons comprises at least the first graphical icon and the second graphical icon, and wherein the subset of the plurality of components comprises at least the first component and the second component.

11. The method of claim 10, wherein the graphical canvas area comprises at least one graphical connection indicator representative of a network connection between two components of the subset of the plurality of components, wherein the network connection between the two components of the subset of the plurality of components comprises at least the network connection between the first component and the second component, and wherein the at least one graphical connection indicator comprises the first graphical connection indicator.

12. The method of claim 11, wherein the topology of the cloud application comprises at least (i) the subset of the plurality of components and (ii) the network connection between the first component and the second component.

13. The method of claim 1, further comprising:
causing display, based on the receipt of the first input, of a graphical webform in the graphical canvas area, wherein the graphical webform comprises a selection element for selecting one of a plurality of variables for configuration of the first component;
receiving, from the client device by the user interface, a fourth input comprising a selection of a first variable of the plurality of variables; and
storing the first variable.

14. The method of claim 1, wherein the operations further comprise:
causing display, based on the receipt of the third input, of a graphical webform in the graphical canvas area, wherein the graphical webform comprises a selection element for selecting one of a plurality of variables for configuration of the network connection between the first component and the second component;
receiving, from the client device by the user interface, a fourth input comprising a selection of a first variable of the plurality of variables; and
storing the first variable.

15. The method of claim 1, wherein the first graphical connection indicator is configured to define (i) the first component as a source in the cloud application and (ii) the second component as a target in the cloud application.

16. The method of claim 1, wherein the operations further comprise:
receiving, from the client device by the user interface, a fourth input configured to cause deployment of the cloud application to the cloud environment hosted by the cloud computing system.

17. The method of claim 16, wherein the fourth input further comprises a selection of a schedule for causing deployment of the cloud application to the cloud environment, wherein the cloud application is configured to be deployed to the cloud environment based on the schedule.

18. The method of claim 1, wherein the operations further comprise:
receiving, from the client device by the user interface and after causing deployment of the cloud application to the cloud environment, a fourth input configured to cause decommissioning of the cloud environment hosted by the cloud computing system.

19. A system for configuration of a cloud application, the system comprising:
executing operations on one or more processors of one or more servers, the operations comprising:
receiving, from a client device by a user interface, a first input comprising a selection of a first graphical icon for addition to a graphical canvas area of the user interface, wherein the first graphical icon is representative of a first component of a plurality of components configured to be included in the cloud application, wherein each of the plurality of components comprise one of: (i) a cloud infrastructure service of a plurality of cloud infrastructure services, (ii) a public containerized service of a plurality of public containerized services, or (iii) a private containerized service of a plurality of private containerized services;
receiving, from the client device by the user interface, a second input comprising a selection of a second graphical icon for addition to the graphical canvas area, wherein the second graphical icon is representative of a second component of the plurality of components;
causing display, based on the receipt of the first and second inputs, of the first graphical icon and the second graphical icon by the graphical canvas area, wherein a topology of the cloud application is configured based on the graphical canvas area;
receiving, from the client device by the user interface, a third input comprising a selection of a first graphical connection indicator between the first graphical icon and the second graphical icon for addition to the graphical canvas area;
causing display, based on the receipt of the third input, of the first graphical connection indicator between the first graphical icon and the second graphical icon by the graphical canvas area, wherein the first graphical connection indicator is representative of a network connection between the first component and the second component; and
causing deployment of the cloud application to a cloud environment hosted by a cloud computing system, wherein the cloud application comprises the topology indicated by the graphical canvas area.

20. The system of claim 19, wherein at least one of the first input, the second input, and the third input are provided by a pointing device communicatively coupled to the client device.
